(19) United States
(12) Patent Application Publication
(10) Pub. No.: US 2004/0080281 A1
(43) Pub. Date: Apr. 29, 2004

(54) Loop-type light string having a reinforced wire

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/282,020

(22) Filed: Oct. 29, 2002

(51) Int. Cl. H05B 37/00

(52) U.S. Cl. 315/185 S; 315/185 R

(57) ABSTRACT

The present invention relates to a loop-type light string having a reinforced wire, wherein the reinforced wire is winded with the electrical wire. The reinforced wire with the electrical wire provides a better strength to support the light string being hanged for decoration that prevents the bulb being released from the electrical wire.

### BACKGROUND OF THE INVENTION

A conventional loop-type light string includes a main electrical wire (1) to connect with several bulbs (2) in interval, as shown in FIG. 1. When a plug of the light string is connected with electrical power, the bulb will be lightened. This prior loop-type light string has a single electrical wire (1) usually. As it is hanged for decoration, the bulb (2) is possibly released from the electrical wire (1) that becomes an electrical contact ineffective and the loop-type light string is lack of utility.

Accordingly, the primary object of the invention is to provide a loop-type light string, which has a reinforced wire being winded with the electrical wire to provide a better supporting for itself. Now the features and advantages of the present invention will be described in detail with reference to the accompanying drawings.

### BRIEF DESCRIPTION OF ACCOMPANYING DRAWINGS

FIG. 1 is a perspective view showing a conventional loop-type light string.

FIG. 2 is a perspective view showing a loop-type light string according to the present invention.

FIGS. 3A, 4A, 5A, and 6A are plan views showing different embodiments of schematic electrical circuits of prior art.

FIGS. 3B, 4B, 5B, and 6B are plan views showing different embodiments of schematic electrical circuits according to the present invention.

FIGS. 7, 8, 9, and 10 are plan view showing the embodiments in FIGS. 3B, 4B, 5B, and 6B respectively.

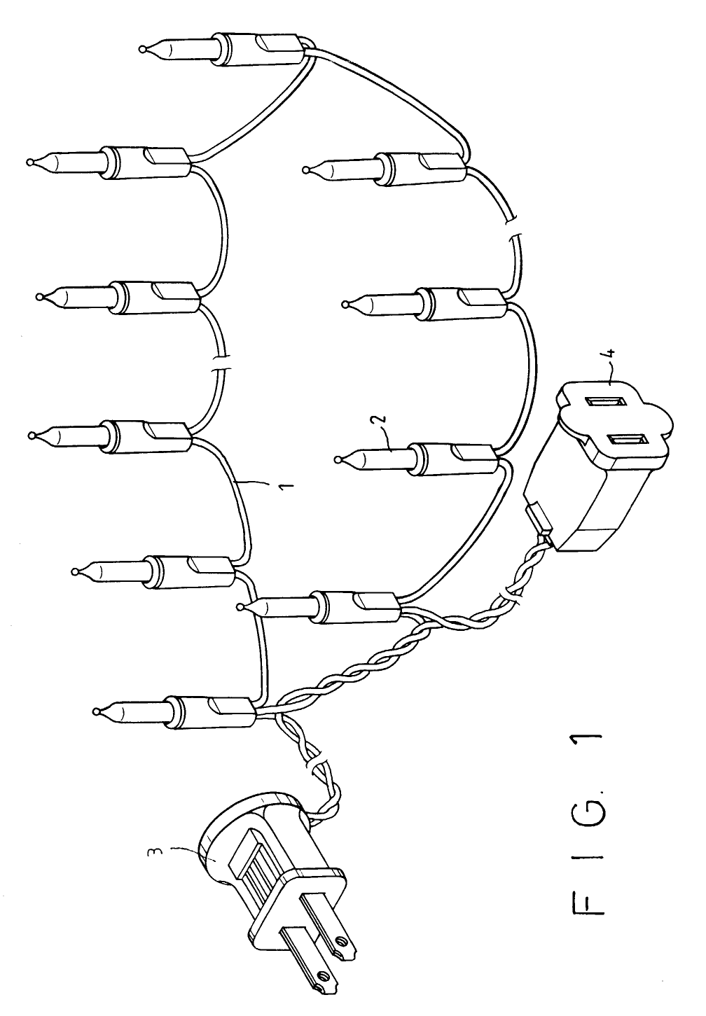

### DETAILED DESCRIPTION OF PREFERRED EMBODIMENTS

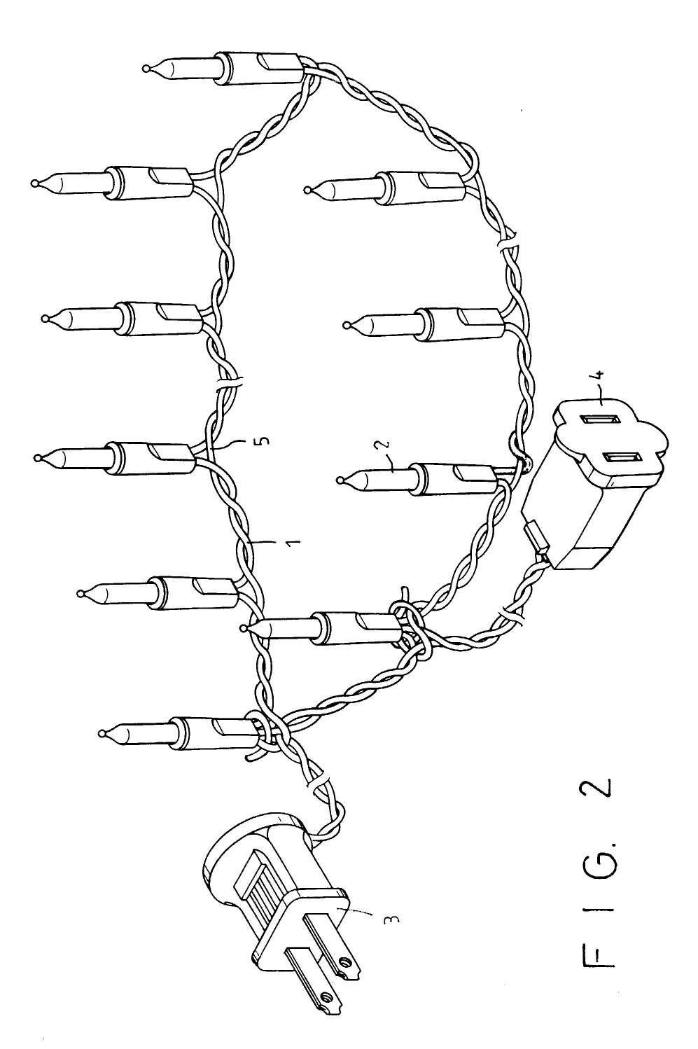

Please refer to FIG. 2 firstly, the present invention relates to a new loop-type light string, which includes an electrical wire (1) connecting with several bulbs (2) in interval as a known one. The electrical wire (1) has its one end connecting with a plug (3) and the other end a socket (4). It is a primary characteristic of this invention to provide with a reinforced wire (5) being winded with the electrical wire (1). Both ends of the reinforced wire (5) are tied with the electrical wire (1) to obtain a secure connection. The reinforced wire (5) can be a non-conductive plastic wire. When the loop-type light string of the present invention is hanged decoratively, the reinforced wire (5) increases strength to support the light string being used and that prevents the bulb (2) being released from the electrical wire (1). The improved loop-type light string can be used effectively.

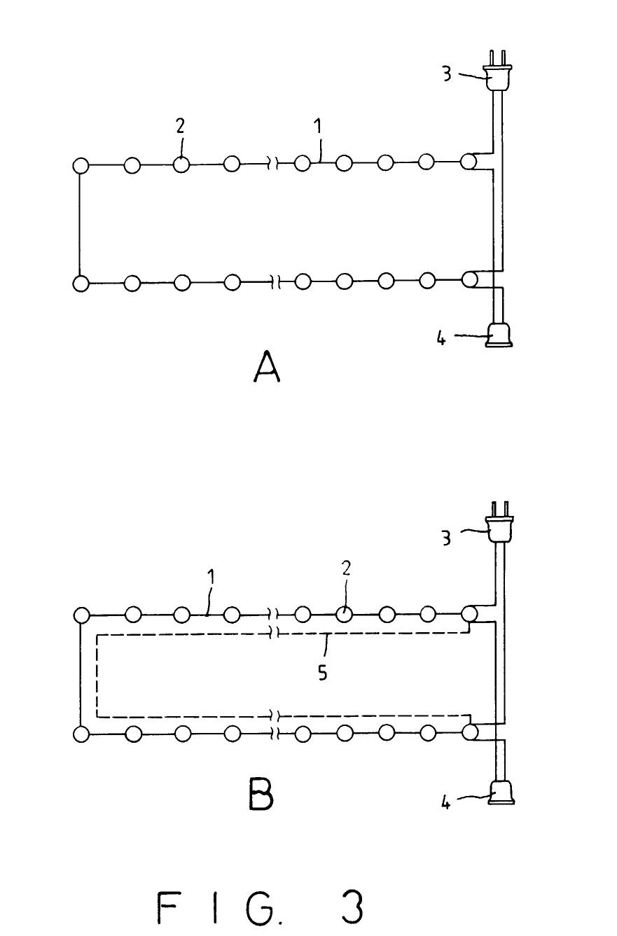

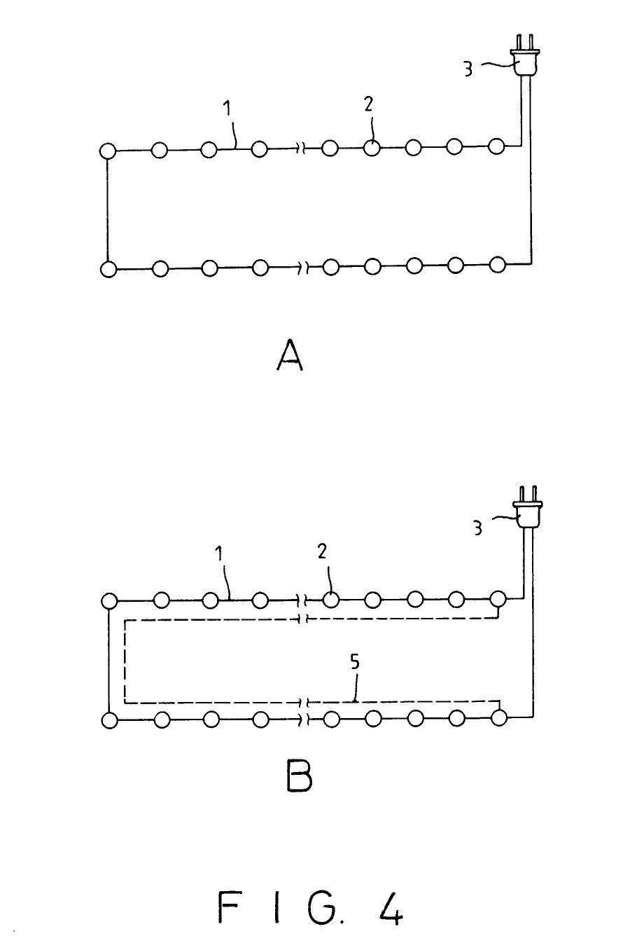

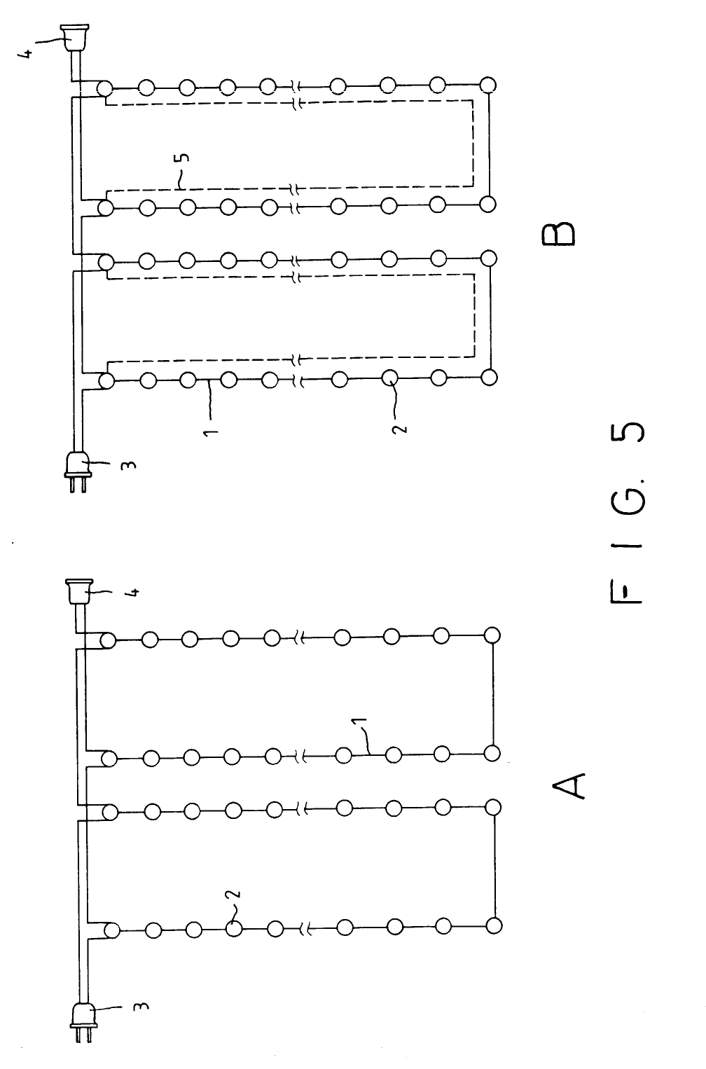

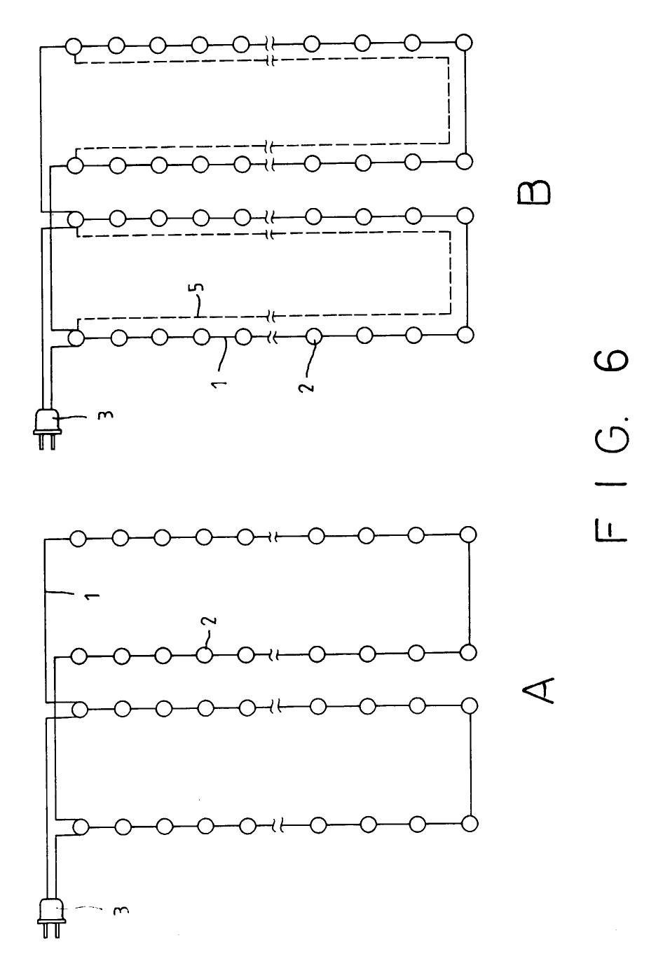

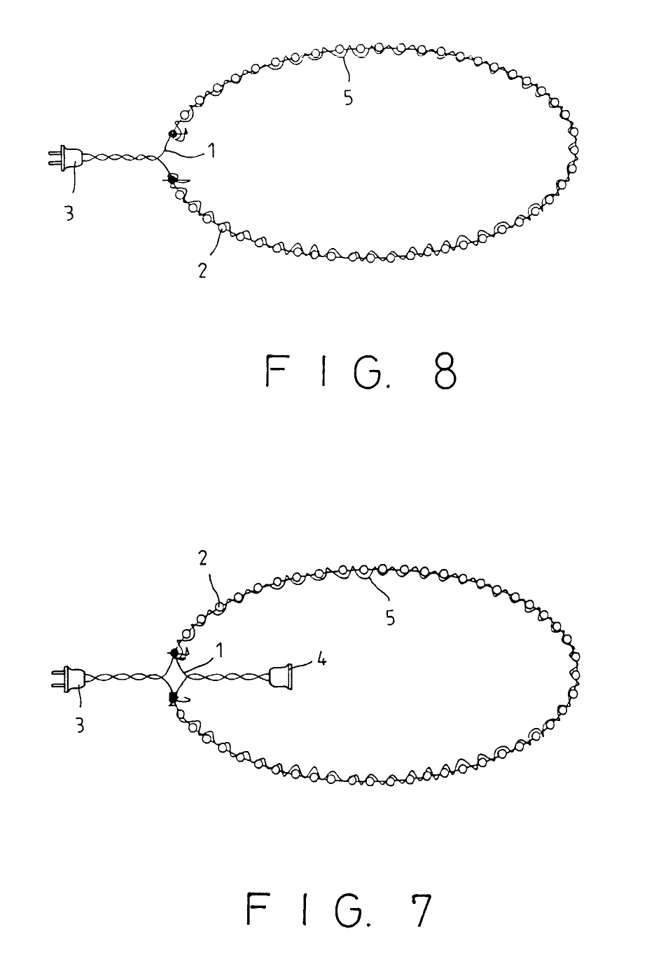

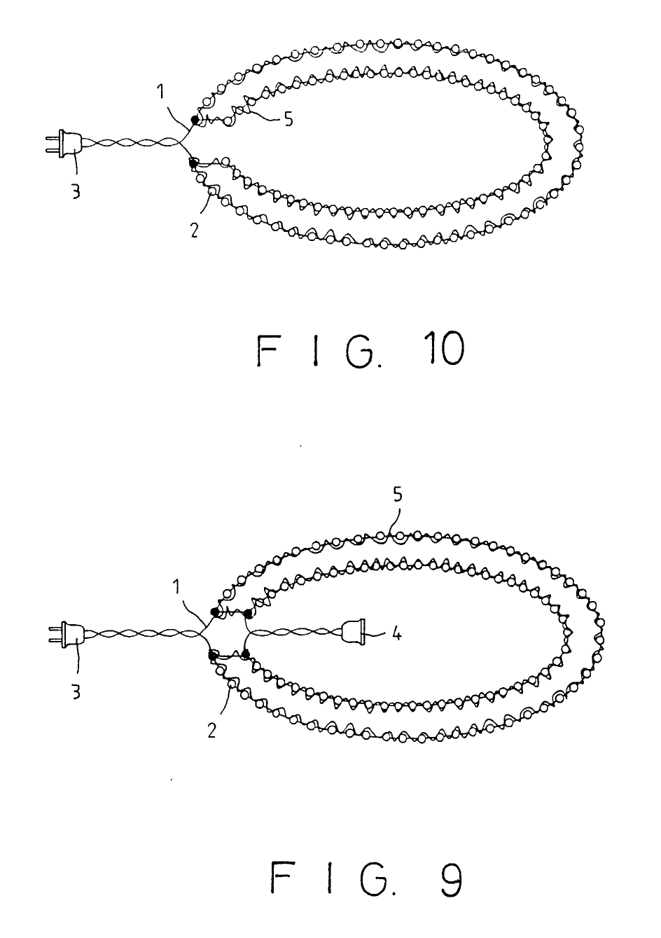

As shown in FIG. 3A and 3B, they show respectively a schematic electrical circuit of the prior string and the loop-type light string of this invention having a plan view in FIG. 7. FIGS. 4A and 4B show the loop-type light string being without a socket (4), wherein the string in FIG. 8 is a plan view of FIG. 4B. FIG. 5A (conventional) and 5B (this invention) are designed with double loops while FIG. 9 is a plan view of FIG. 5B. FIGS. 6A (conventional) and 6B (this invention) are designed with double loops without the socket (4) while FIG. 10 is a plan view of FIG. 6B.

Accordingly, the present invention can provide a reinforced strength for the loop-type light string when it is hanged for decoration that obviously achieves utility and improvement that should be granted for patent. The aforesaid embodiments are only examples those are not to limit the scope of the present invention. Any modification with the same spirit should be included in the claims of this invention.

What is claimed is:

1. A loop-type light string having a reinforced wire including an electrical wire connecting with several bulbs in interval, and is characterized in that a reinforced wire is winded with the electrical wire to become a connecting structure.

2. The loop-type light string as claimed in claim 1, wherein both ends of the reinforced wire are tied with the electrical wire in secure.

3. The loop-type light string as claimed in claim 1, wherein the reinforced wire is a non-conductive plastic wire.
